(19) United States
(12) Patent Application Publication
(10) Pub. No.: US 2016/0128368 A1
(43) Pub. Date: May 12, 2016

(54) Snack Bars Containing Psyllium

(71) Applicant: The Procter & Gamble Company, Cincinnati, OH (US)

(72) Inventors: Mary Lynn Jump, Fairfield, OH (US); Lori Jean Toman, Terrace Park, OH (US); Teresa Lynn Zuidema, Hyde Park, OH (US)

(21) Appl. No.: 14/534,238

(22) Filed: Nov. 6, 2014

(51) Int. Cl. A23L 1/164; A23L 1/308

(52) U.S. Cl. CPC A23L 1/1643; A23L 1/3081; A23V 2002/00

(57) ABSTRACT

A reference amount commonly consumed (RACC) of an organoleptically acceptable snack bar. The snack bar can contains from about 3 g to about 6 g fiber where the fiber can contain from about 1 g to about 3 g of soluble fiber. The soluble fiber can be from psyllium and the bar can contain from about 2 g to about 4 g psyllium. The snack bar can also contain a whole grain product. The snack bar can have less than 3 g of fat and from about 135 to about 180 calories per serving. Furthermore, the snack bar may not be baked.

### FIELD OF THE INVENTION

The present invention is directed towards a snack bar containing psyllium, particularly a snack bar that is organoleptically acceptable.

### BACKGROUND OF THE INVENTION

Consuming fiber has many health benefits. The overall health benefits of fiber can be determined, in part, by its physical attributes, particularly solubility and viscosity. Soluble viscous fiber such as psyllium, can promote digestive health by relieving constipation and normalizing bowel movements and can help to lower cholesterol, curb hunger, and maintain healthy blood sugar levels.

Unfortunately, Americans consume less than half of the recommended daily fiber amount (38 and 25 g/day for men and women aged 19-50, respectively) and fewer than 5% of people get enough fiber from their diet. Thus, many consumers want convenient foods and supplements, including snack bars that are a good source of fiber and many consumers are interested in consuming more psyllium due to its health benefits.

However, incorporating psyllium into food products, such as snack bars can be difficult. Psyllium is a known mucilaginous material, which acquires a slimy or adhesive texture and mouthfeel upon hydration, often resulting in a product that is not highly palatable. Furthermore, psyllium can develop a distinctive, undesirable flavor in the presence of heat and moisture, which further limits its use in food products. Consequently, snack bars that contain psyllium can often have an unsatisfactory taste, texture, and mouthfeel.

Therefore, there is a need for a snack bar that contains psyllium that is also organoleptically acceptable.

### SUMMARY OF THE INVENTION

A reference amount commonly consumed (RACC) of an organoleptically acceptable psyllium snack bar comprising: (a) from about 3 g to about 6 g fiber wherein the fiber comprises from about 1 g to about 3 g soluble fiber; (b) from about 2 g to about 4 g psyllium; (c) a whole grain product; wherein the snack bar comprises less than about 3 g fat and wherein the snack bar comprises from about 135 to about 180 calories per RACC and wherein the snack bar is not baked.

An RACC of an organoleptically acceptable psyllium snack bar comprising: (a) from about 0.5 g to about 4 g of soluble fiber from psyllium; (b) a whole grain; (c) a dried fruit; wherein the snack bar is low in fat, low in saturated fat, and does not comprise cholesterol and wherein the snack bar is from about 100 to about 280 calories per RACC and wherein the snack bar comprises a weight ratio of protein to fiber of from about 0.25 to about 1.5.

An organoleptically acceptable psyllium snack bar comprising: (a) at least about 50 mg/g fiber wherein the fiber comprises at least about 25 mg/g soluble fiber; (b) at least about 10 mg/g psyllium; (c) a whole grain; wherein the snack bar comprises a weight ratio of protein to fiber of from about 0.25 to about 1.5 and wherein a consumer prefers the psyllium snack bar to a psyllium snack bar that does not have a weight ratio of protein to fiber of from about 0.25 to about 1.5 in a taste test.

### BRIEF DESCRIPTION OF THE DRAWINGS

FIG. 1 shows taste testing data comparing the overall taste of commercially available snack bar products that contain psyllium; and

FIG. 2 shows taste testing data comparing the overall taste of the snack bars of the present invention with the overall taste of commercially available snack bar products.

### DETAILED DESCRIPTION OF THE INVENTION

Consumers are looking for tasty and convenient ways to incorporate more fiber into their diets, in particular cholesterol lowering soluble fibers such as psyllium. Snack bars, including but not limited to granola bars and cereal bars, are a fast and convenient snack that can include fiber. However, it is difficult to incorporate psyllium into a snack bar.

Many consumers who eat snack bars containing psyllium, do not find these products organoleptically acceptable. After mastication and contact with the consumer's saliva, the psyllium in snack bars can become gummy and gritty and can also have an undesirable taste. The psyllium can also become packed into the consumer's teeth and can coat her mouth. It can be difficult to remove the psyllium residue from the teeth and mouth.

The snack bar of the present invention can be organoleptically acceptable while comprising at least about 2.5 grams of fiber. Which includes at least about 1.5 grams of soluble fiber from psyllium per reference amount commonly consumed (RACC). The snack bars can also be low in fat, low in saturated fat, and have no cholesterol. The snack bar can have about 150 calories per RACC. The snack bars can provide a healthy choice help satisfy hunger and/or reduce hunger. In one example, the snack bars are not intended as a meal replacement. Additionally, the snack bars can help lower cholesterol and promote heart health.

The snack bar also can contain grains such as rolled oats and crisp rice, which is made out of rice flour, malt extract, and salt. The snack bar can also contain nuggets made from air popped cereals or extruded products. Some of the grains can be relatively large pieces. For example, many of the crisp rice and rolled oats pieces can be greater than about 5 mm long and greater than about 3 mm wide. The grain pieces can add some crunchiness and texture to the snack bar. In one example, the snack bars can have a chewy texture.

The snack bar can also contain dried fruit pieces, such as raisins and/or cranberries. The dried fruit pieces can add sweetness as well as a chewy texture. While not wishing to be bound by theory, it is believed that the texture and crunchiness from the grain pieces and/or the chewiness from the fruit can help distract the consumer's palette from the texture of the psyllium. Furthermore, the chewiness from the dried fruit can help disguise the gumminess of the psyllium.

In another example, the snack bar can contain syrups and liquid ingredients such as plasticizers. In one example, the plasticizer can be glycerin. The viscosity of the syrups can be controlled to slow the absorption into the grains, crisp rice and/or nuggets, which results in a crispy texture instead of a texture that is too hard. Furthermore, the high viscosity syrups can further help disguise the gumminess of the psyllium.

The snack bar can also have a coating. The coating can be on one or more sides. In one example the coating can be drizzled across the top side. In another example, the coating can substantially cover one side. The coating can be made of a sweetener and can have a crunchy texture. It is believed that the coating can further distract the consumer's pallet from the texture of the psyllium, as well as provide additional sweetness.

In one example, the psyllium is approximately evenly dispersed throughout the snack bar, which can also help improve the taste of the snack bar. In one example, the psyllium can be steam sanitized. Steam sanitization can destroy microbes without significantly changing the flavor of the psyllium or adding additional chemicals. In another example, the psyllium is not sanitized with chemicals. Additional information on steam sanitization can be found in U.S. Pat. Nos. 4,911,889 and 5,229,117. The particle size of the psyllium can influence the overall mouth feel of the snack bar. If the particle size is too large, the snack bar can taste grainy. However, if the psyllium is too small, it can break into fines, which makes it difficult to incorporate into snack bars. In one example, the mean particle size is from about 25 μm to about 250 μm, in another example from about 50 μm to about 200 μm, and in another example from about 75 μm to about 125 μm.

In one example, the snack bar is not baked. Baking can cause physical and chemical reactions that can change the physical and chemical properties of the ingredients. For instance, baking can change the taste of some ingredients.

The snack bar can have a shelf life of at least about 12 months, in another example at least about 18 months, and in another example at least about 24 months. The water activity (Aw) can be from about 0.05 to about 0.35. In one example, the snack bar can have a water activity in this range for the entire shelf life. In another example, the snack bar can have an Aw of less than about 0.6 after 12 months, in another example less than about 0.5 after 12 months, and in another example less than about 0.4 after 12 months. Water activity can be determined as described hereafter in the Water Activity Test Method.

As used herein, “calorie” refers to a unit of food energy and is equivalent to the amount of energy needed to raise the temperature of one kilogram of water by one degree Celsius.

As used herein, “dietary fiber” or “fiber” refers to the fibrous or gummy component of food that is indigestible and non-metabolizable by humans. Fiber can include soluble fiber and insoluble fiber.

As used herein, “insoluble fiber” refers to fiber that does not dissolve in water. Insoluble fiber can be metabolically inert and can provide bulking and/or prebiotic benefits.

As used herein, “psyllium” refers to ground psyllium or ispaghula husk. Psyllium is from the seeds of Plantago ovata or Plantago psyllium. In one example, the psyllium husk is from Plantago ovata. It is believed that the husk contains the highest concentration of the fiber and the ground husk is used for a source of psyllium fiber.

As used herein, “reference amount customarily consumed” or “RACC” refers to the reference amounts customarily consumed per eating occasion. On food packages, the RACC is commonly referred to as the “serving” or the “suggested serving”. The RACC can be any suitable size. In one example the RACC can be from about 20 g to about 100 g, in another example from about 25 g to about 80 g, in another example from about 30 g to about 70 g, in another example from about 33 g to about 60 g, in another example from about 35 g to about 50 g, in another example from about 37 g to about 45 g, and in another example from about 38 g to about 43 g. In one example, the RACC is about 40 g.

As used herein, “soluble fiber”, refers to dietary fiber that is water soluble or water swellable. Non-limiting examples of sources of soluble fiber can include psyllium, beta glucan, oat bran, oat groat, pectin, carrageenan, guar gum, locust bean gum, gum acacia, xanthan gum, and combinations thereof.

As used herein, “water activity” (Aw) is the ratio from the vapor pressure of the material divided by the vapor pressure of the air at the same temperature.

Two taste tests were performed to assess snack bars that contained psyllium. The first taste test had about 100 consumers and the psyllium bar they sampled was Gnu® Foods Fiber Love™ Bars in a chocolate brownie flavor. The nutritional information and ingredients for the Gnu® Foods Fiber Love™ Bars as well as the commercial products can be found in Table 4 and accompanying text, hereafter.

The second taste test had about 75 consumers, all of whom participated in the first taste test, and they tested the three FiberWise® bars. The taste test was performed as a blind sequential monadic test. Each consumer received a whole unwrapped bar on a plate and were instructed to consume at least half of the bar. The consumers gave each bar an overall qualitative rating of excellent, very good, good, fair, or poor based on his or her overall rating based on perception and taste of the snack bar. Then, the ratings were converted to a numerical value and the mean was calculated. An excellent rating scored 100, very good scored 75, good scored 50, fair scored 25, and poor scored 0.

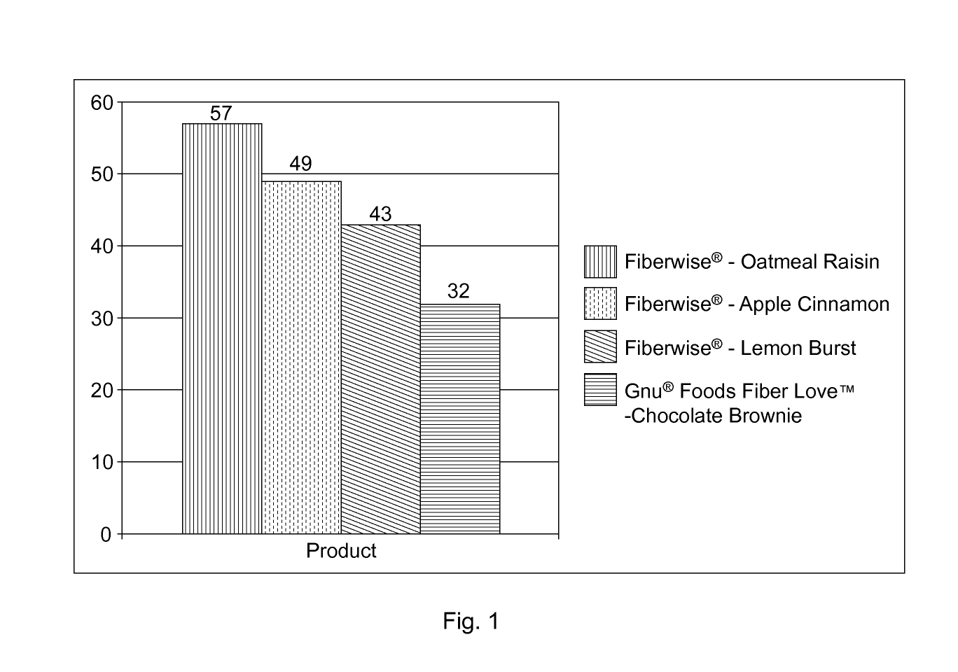

FIG. 1 shows the mean overall rating from the taste test with the commercial snack bars that contained psyllium. The FiberWise® Oatmeal Raisin had a mean score of 57, corresponding to slightly above good, while the other bars were rated less favorably. The other FiberWise® bars had a mean score of less than 50 and the Gnu® snack bar had a mean score of 32.

Additionally, the panelists were also asked to rate various product attributes, such as stickiness in teeth, residual particles in mouth, and aftertaste. The panelists were given nine qualitative ratings, as shown in Table 1 below. The qualitative rating was then converted to a numerical value, as shown in Table 1 and the mean was calculated for each product attribute.

TABLE 1

| | Qualitative Rating | | | | | | | | |
|---|---|---|---|---|---|---|---|---|---|
| | Dislike | | | | | | Like | | Like the |
| | the Most | Dislike | Dislike | | | | Very | Like | Most |
| | Possible | Extremely | Very Much | Dislike | Neutral | Like | Much | Extremely | Possible |
| Numerical | −4 | −3 | −2 | −1 | 0 | +1 | +2 | +3 | +4 |
| Value | | | | | | | | | |

The mean numerical results from the product attributes are shown in Table 2 below. Table 2 shows that for overall liking and taste, the panelists are approximately neutral for all three FiberWise® bars. The panelists also disliked many of the attributes of the Gnu® Foods Fiber Love™ bars.

TABLE 2

| | | | | Gnu ® |
|---|---|---|---|---|
| | | | | Foods |
| | | | FiberWise ® | Fiber |
| | FiberWise ® | FiberWise ® | Chewy Fiber | Love ™ |
| | Fruit & Fiber | Chewy Fiber | Bars - | Bars - |
| | Bars - Apple | Bars - Oatmeal | Lemon | Chocolate |
| | Cinnamon | Raisin | Burst | Brownie |
| | n = 75 | n = 72 | n = 73 | n = 102 |
| Overall Liking | 0.6 | 1.1 | 0.2 | −0.4 |
| Overall Taste | 0.8 | 1.0 | 0.3 | −0.4 |
| Appearance | 0.6 | 1.6 | 1.4 | −0.6 |
| Size | 1.3 | 1.7 | 1.6 | 0.7 |
| Thickness | 1.3 | 1.6 | 1.4 | 0.5 |
| Flavor | 0.7 | 0.9 | 0.04 | −0.7 |
| Sweetness | 1.0 | 1.1 | 0.2 | −0.4 |
| Graininess | 0.7 | 1.1 | 0.6 | −0.4 |
| Stickiness in | 0.1 | 0.8 | 0.6 | −0.3 |
| teeth | | | | |
| Residual | 0.1 | 0.8 | 0.6 | −0.4 |
| particles in | | | | |
| mouth | | | | |
| Aftertaste | 0.6 | 0.8 | 0.1 | −0.6 |

Another taste testing study was performed with 175 consumers. In this study, Example 1 (Cinnamon Raisin), Example 2 (Cranberry Lemon), and Example 3 (Berry) were each flavor matched with two commercially available snack bar products, one that is generally found in the nutrition aisle of the grocery store and another that is generally found in the cereal aisle. Each sample was placed in a blind sequential monadic taste test, where each consumer tasted all nine products but did not know what they tasted. Each consumer received an uncut bar that weighed between 20-25 grams and evaluated the bars to give an overall rating and rated various attributes. The consumers gave a qualitative rating of excellent, very good, good, fair, or poor for the overall rating and each attribute. These qualitative ratings were then converted to numerical scores as described above and the mean was calculated. The nutritional information and ingredients for Examples 1, 2, and 3, as well as the commercial products can be found in Tables 5, 6, and 7 and accompanying text, hereafter.

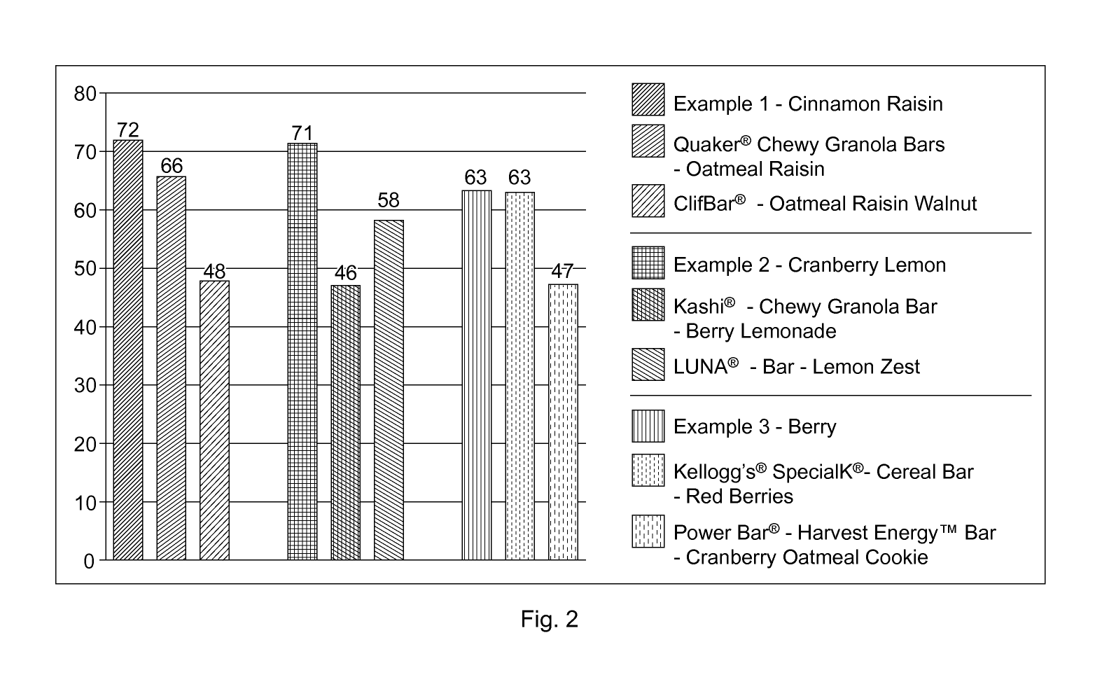

FIG. 2 shows the results from the taste test for the mean overall rating. Example 1 (Cinnamon Raisin) and Example 2 (Cranberry Lemon) were rated significantly higher (p<0.05) than all other bars tested. Example 3 (Berry) is rated significantly higher (p<0.05) than the nutrition aisle product, a cranberry oatmeal cookie PowerBar® Harvest Energy™, which contains psyllium, and parity to the cereal aisle product, Kellogg's® Special K® Red Berries cereal bar. It is important to note, that only one of the commercially available snack bar products contained psyllium and the exemplary snack bars of the present invention were rated higher or at parity with the other bars that were tested. Thus, the high ratings are even more surprising, since making psyllium snack bars that are organoleptically acceptable can be difficult.

Furthermore, at least 80% of the study participants thought that Examples 1, 2, and 3 met or exceeded their expectations and at least 40% of the study participants thought that Examples 1, 2, and 3 were better than any snack bar they had ever tried.

Table 3 below, shows the mean overall rating and mean rating for each product attribute for the three examples and six commercially available bars. Surprisingly, Examples 1, 2, and 3 had a mean score that was higher or about the same as the commercially available products. It is especially surprising that the consumers preferred the graininess and chewiness of Examples 1, 2, and 3 over all of the commercially available bars, as these qualities are difficult to achieve when formulating snack bars, especially those containing psyllium. Consumers also liked the flavor of Examples 1 and 2 better than any other snack bar. Again, this is surprising because sometimes psyllium has an off flavor.

TABLE 3

| | | | | | Power Bar ® | | Quaker ® | | |
|---|---|---|---|---|---|---|---|---|---|
| | | | | Clif | Harvest | | Chewy ® | | Kashi ® |
| | | | | Bar ® - | Energy ™ Bar - | | Granola | Kellogg's ® | Chewy |
| | Ex. 1 - | Ex. 2 - | | Oatmeal | Cranberry | | Bar - | Special K ® | Granola |
| | Cinnamon | Cranberry | Ex. 3 - | Raisin | Oatmeal | Luna ® Bar - | Oatmeal | Cereal Bar - | Bar- Berry |
| | Raisin | Lemon | Berry | Walnut | Cookie | LemonZest ® | Raisin | Red Berries | Lemonade |
| Overall | 71.92 | 71.35 | 63.2 | 47.74 | 47.23 | 58.2 | 65.74 | 62.65 | 46.98 |
| Rating | | | | | | | | | |
| Overall | 75.26 | 76.3 | 69.77 | 39.55 | 49.78 | 63.27 | 63.93 | 65.08 | 69.81 |
| appearance | | | | | | | | | |
| Size | 71.46 | 72.93 | 66.84 | 55.04 | 54.77 | 70.28 | 58.77 | 57.41 | 71.95 |
| Thickness | 73.17 | 73.62 | 67.96 | 58.22 | 60.05 | 71.77 | 64.13 | 65.54 | 71.11 |
| Aroma | 71.15 | 72.19 | 67.91 | 51.43 | 55.65 | 65.79 | 65.76 | 68.1 | 57.46 |
| Chew | 80.44 | 77.7 | 75.00 | 49.72 | 46.76 | 68.98 | 65.99 | 59.38 | 40.39 |
| Swallow | 80.33 | 77.81 | 74.6 | 48.73 | 47.22 | 68.2 | 67.71 | 64.38 | 44.03 |
| Flavor | 74.11 | 70.94 | 65.77 | 48.62 | 51.22 | 59.62 | 69.14 | 67.29 | 46.41 |
| Sweet | 69.46 | 67.88 | 64.15 | 48.97 | 53.77 | 60.61 | 65.73 | 62.15 | 49.52 |
| Spice | 68.06 | 61.99 | 59.11 | 49.17 | 47.45 | 55.83 | 61.54 | 55.86 | 45.25 |
| Grain | 71.22 | 70.08 | 66.86 | 48.72 | 45.72 | 60.09 | 66.86 | 62.13 | 53.83 |
| Chewiness | 75.95 | 73.92 | 72.32 | 52.18 | 49.69 | 67.01 | 67.78 | 60.99 | 44.77 |
| Crunch | 63.9 | 66.87 | 57.83 | 38.57 | 43.51 | 60.85 | 62.97 | 65.13 | 53.04 |
| Moist | 79.18 | 75.97 | 71.88 | 54.21 | 44.44 | 66.75 | 62.33 | 60.52 | 37.68 |
| Aftertaste | 71.12 | 66.92 | 63.55 | 49.29 | 52.11 | 56.12 | 68.3 | 63.09 | 48.9 |

In another study, consumers who had purchased nutrition bars in the last twelve months, sampled the snack bar from Example 1 or 2 and ranked it as follows: (1) The best cereal/nutrition/fiber bar I have ever tasted; (2) slightly better than any other bar I have ever used; (3) The same as any other bar I have ever used; (4) Slightly worse than any other bar I have ever used; and (5) The worst cereal/nutrition/fiber bar I have ever used. Surprisingly, 70% of the consumers ranked Example 1 in the top two, as the best cereal/nutrition/fiber bar or slightly better than any other bar and 69% of consumers ranked Example 2 in the top 2. Also, 16% of consumers ranked Example 1 as the best bar they had ever tasted and 18% of consumers ranked Example 2 as the best bar they had ever tasted. 90% of consumers ranked Example 1 in the top three, as the best bar, slightly better, or the same as any other bar and 87% of consumers ranked Example 2 in the top three. This is surprising because very few bars contain psyllium and it is surprising that a bar that contains psyllium can be as good as or better than other bars.

The snack bar can provide a healthy snack. The snack bar can be low fat, low saturated fat, and contain no cholesterol.

In one example, consumers who tasted the snack bar were more likely to consume and/or purchase the bar again. In another example, consumers who begin a regimen that includes the snack bar can be more likely to remain on the regimen.

The snack bar can contain less than about 250 calories per RACC, in another example less than about 225 calories per RACC, in another example less than about 200 calories per RACC, in another example less than about 180 calories per RACC, in another example less than about 150 calories per RACC, in another example less than about 125 calories per RACC, and in another example less than about 100 calories per RACC. In another example the snack bars can comprise from about 80 to about 300 calories per RACC, in another example from about 100 to about 280 calories per RACC, in another example from about 125 to about 230 calories per RACC, in another example from about 130 to about 200 calories per RACC, in another example from about 135 to about 180 calories per RACC, and in another example from about 140 to about 160 calories per RACC. In one example, the bar can contain about 150 calories per RACC.

In one example, the snack bar comprises from about 1 to about 10 calories/g, in another example from about 2 to about 7 calories/g, and in another example from about 3 to about 4.5 calories/g.

In one example, the snack bars can be low fat. As used herein, low fat means that the snack bar contains less than or equal to 3 g of fat per RACC. In another example, the snack bar can contain less than about 100 mg/g fat, in another example less than about 90 mg/g, in another example less than about 80 mg/g, and in another example less than about 75 mg/per g.

In another example, the snack bar can contain from about 0.5 to about 20 g fat per RACC, in another example from about 1 to about 18 g fat per RACC, in another example from about 2 to about 16 g fat per RACC, in another example from about 3 to about 13 g fat per RACC, in another example from about 3 g to about 10 g fat per RACC. In one example the composition comprises less than about 18 g fat per RACC, in another example less than about 15 g fat per RACC, in another example less than about 12 g fat per RACC, in another example less than about 10 g fat per RACC, in another example less than about 7 g fat per RACC, in another example less than about 5 g fat per RACC, in another example less than about 4 g fat per RACC, in another example less than about 3 g fat per RACC, in another example less than about 2 g fat per RACC, and in another example less than about 1 g fat per RACC. In another example, the snack bar can contain from about 70 to about 450 mg fat per g, in another example from about 80 to about 370 mg fat per g, and in another example from about 125 to about 250 mg of fat per g.

In another example, the snack bar can have low saturated fat. As used herein, low saturated fat means that the snack bar contains less than or equal to one gram of saturated fat per RACC. In another example, the snack bar comprises less than about 40 mg/g saturated fat, in another example less than about 35 mg/g saturated fat, in another example less than about 30 mg/g saturated fat, in another example less than about 30 mg/g saturated fat, and in another example less than about 25 mg/g saturated fat.

In another example, the snack bar contains no cholesterol. As used herein, no cholesterol means that the snack bar contains less than 2 mg cholesterol per RACC. In one example, the snack bar contains about 0 g of cholesterol. In another example, the snack bar comprises less than about 100 μg/g of cholesterol, in another example less than about 75 μg/g of cholesterol, in another example less than about 50 μg/g cholesterol, and in another example less than about 30 μg/g cholesterol.

In another example, the snack bar contains protein. In one example, the snack bar can contain from about 0.5 g protein to about 8 g protein per RACC, in another example from about 1 g protein to about 6 g protein per RACC, in another example from about 1.5 g protein to about 4 g protein per RACC, and in another example the snack bar contains about 2 g protein per RACC. In another example the snack bar can contain from about 5 g protein to about 20 g protein per RACC, in another example from about 8 g protein to about 15 g protein, and in another example from about 10 g protein to about 13 g protein. In another example, the snack bar comprises from about 25 mg/g to about 300 mg/g protein, in another example from about 35 mg/g to about 200 mg protein, in another example from about 40 mg/g to about 150 mg/g protein, and in another example from about 50 mg/g to about 100 mg/g protein.

In another example, the snack bar contains fiber. The fiber can include both soluble and insoluble fiber. In one example, the snack bar can contain from about 0.5 g to about 12 g of fiber per RACC, in another example from about 1 g to about 10 g of fiber per RACC, in another example from about 2 g to about 8 g of fiber per RACC, in another example from about 3 g to about 6 g of fiber per RACC, and in another example from about 3.5 g to about 4 g fiber per RACC. In another example, the snack bar can contain less than about 12 g fiber per RACC, in another example less than about 9 g fiber per RACC, and in another example less than about 5 g fiber per RACC.

The snack bar can contain soluble fiber. In another example, the snack bar can contain from about 0.5 g to about 6 g soluble fiber per RACC, in another example from about 1 g to about 4 g soluble fiber per RACC, in another example from about 2 g to about 3.5 g soluble fiber per RACC, and in another example from about 2.5 g to 3 g soluble fiber per RACC. In one example a portion of the soluble fiber can come from psyllium and/or whole grains such as rolled oats. In one example the snack bar comprises from about 0.5 g to about 4 g of soluble fiber from psyllium per RACC, in another example from about 1 g to about 3 g of soluble fiber from psyllium, in another example from about 1.25 g to about 2.5 g of soluble fiber from psyllium, and in another example from about 1.5 g to about 2.0 g of soluble fiber from psyllium. In one example, the bar comprises about 1.8 of soluble fiber from psyllium per RACC.

In another example, the snack bar can contain greater than about 50 mg/g fiber, in another example greater than about 75 mg/g fiber, in another example greater than about 90 mg/g fiber, and in another example greater than about 100 mg/g fiber. In another example, the snack bar can contain greater than about 25 mg/g soluble fiber, in another example greater than about 50 mg/g soluble fiber, and in another example greater than about 75 mg/g soluble fiber.

In another example, the snack bar can contain psyllium. In one example the snack bar can contain from about 0.5 g to about 6 g psyllium per RACC, in another example from about 1 g to about 5 g psyllium, in another example from about 2 g to about 4 g psyllium, and in another example from about 2.25 g to about 3.5 g psyllium. In another example, the snack bar can contain about 2.8 g of psyllium per RACC. In another example, the snack bar can contain greater than about 10 mg/g psyllium, in another example greater about 25 mg/g psyllium, in another example greater than about 50 mg/g psyllium, and in another example greater than about 50 mg/g psyllium.

In one example, the snack bar contains less than 15 g sugar per RACC, in another example less than 13 g sugar per RACC, in another example less than 10 g sugar per RACC, in another example less than 7 g sugar per RACC, and in another example less than 5 g sugar per RACC. In another example, the snack bar contains more than about 8 g sugar per RACC, in another example more than about 10 g sugar per RACC, and in another example more than about 11 g sugar per RACC.

In another example, the snack bar contains from about 0.1 to about 0.5 g sugar per g, in another example from about 0.2 to about 0.4 g sugar per g, and in another example from about 0.25 to about 0.35 g sugar per g.

Non-limiting examples of sweeteners can include sugars, sugar substitutes, and combinations thereof. Non-limiting examples of sugars can include glucose, sucrose, fructose, corn syrup, high fructose corn syrup, agave nectar, honey, maple sugar, molasses, invert sugar, and combinations thereof. Non-limiting examples of sugar substitutes can include dextrose, stevia, aspartame, sucralose, neotame, acesulfame, potassium, sodium saccharin, xylitol, sugar alcohols including xylitol, sorbitol, mannitol, maltitol, lactitol, isomalt, erythritol, and glycerin; and combinations thereof.

In one example, the snack bar is substantially free of high fructose corn syrup. In another example, the snack bar is substantially free of sugar alcohols.

Dietary fibers can differ considerably in their chemical and physical properties, which can impact the health benefits associated with the fiber. Fibers can be classified as insoluble fibers, which do not dissolve in water, and soluble fibers, which dissolve in water. Soluble fibers can be further divided into viscous (i.e. gel-forming) or nonviscous types. Non-limiting examples of insoluble fibers can include wheat bran and cellulose. Soluble viscous fiber can come from psyllium, oats and barley, while nonviscous fibers can come from inulin, partially hydrolyzed guar gum, wheat dextrin, or acacia.

In another example, an additional source of fiber can be added to the snack bar. Non-limiting examples of additional sources of fiber can include grains and seeds, root extracts, and combinations thereof. Non-limiting examples of root extract can include konjac (glucomannan), chicory (inulin), and combinations thereof. Non-limiting examples of grains and seeds can include oats, barley, wheat, wheat bran, rye, rice including brown rice, psyllium, chia, buckwheat, quinoa, amaranth, flax, faro, spelt, emmer, einkorn, kamut, millet, maize, tricale, teff, and combinations thereof. The grains and seeds can be whole, bran, flaked rolled or processed in any suitable manner. In another example, the grains and seeds can be whole grain products that can include whole wheat flour, rolled oats or oat groats, triticale flour, popcorn, and teff flour.

In one example, the snack bar can contain dried fruit. Non-limiting examples of dried fruit can include raisins, dates, prunes (dried plums), figs, apricots, peaches, apples, pears, cranberries, blueberries, cherries, strawberries, mango, papaya, kiwi fruit, pineapple, and combinations thereof.

In another example, the snack bar can contain nuts. The snack bar can contain the entire nut, a portion of the nut, and/or a ground nut. In another example, the snack bar can contain nut butter, such as peanut butter, shea butter, almond butter, and the like. Non-limiting examples of tree nuts can include almonds, beechnuts, Brazil nuts, butternuts, cashews, chestnuts, coconut, filbert, hazelnuts, hickory, macadamia nuts, peanuts, pecans, pine nuts, pistachios, shea nuts, walnuts, and combinations thereof.

In another example, the snack bar can be fortified with vitamins and minerals. Non-limiting examples of vitamins and minerals can include vitamin C, vitamin B1 (thiamin), vitamin B2 (riboflavin), vitamin B3 (niacin), vitamin B6, vitamin B9 (folic acid), vitamin B12, vitamin B5 (pantothenic acid), biotin, vitamin A, vitamin E, vitamin D2, vitamin D3 (cholecalciferol), potassium, iodine, selenium, borate, zinc, calcium, magnesium, manganese, molybdenum, betacarotene, iron, and combinations thereof.

In one example, the snack bar can contain a candy. Non-limiting examples of candy can include caramel, molasses, chocolate, and combinations thereof. The candy can be in pieces, such as chips or chunks, a coating, a drizzle, a syrup incorporated into the snack bar, or combinations thereof. In one example, the candy is in a powder, such as cocoa powder. Non-limiting examples of chocolate can include milk chocolate, dark chocolate, white chocolate, and combinations thereof.

In another example, the snack bar can contain probiotics.

In one example the snack bar can have a weight ratio of sugar to fiber of about 1.5 to about 5, in another example from about 2 to about 4, and in another example from about 2.5 to about 3.5.

In another example the snack bar can have a weight ratio of fat to fiber of about 0.4 to about 3, in another example from about 0.45 to about 2, in another example from about 0.5 to about 1, and in another example from about 0.55 to about 0.75. In another example the snack bar can have a weight ratio of fat to fiber greater than about 0.4, in another example greater than about 0.5, and in another example greater than about 1.

In another example the snack bar can have a weight ratio of protein to fiber of about 0.25 to about 1.5, in another example from about 0.3 to about 1, in another example from about 0.35 to about 0.75, and in another example from about 0.4 to about 0.6.

The snack bar can be taken with at least a full glass (8 oz., 237 mL) of any hot or cold beverage. The snack bar can be eaten in-between meals or with a meal. In one example, the consumer eats the snack bar as a meal replacement, for instance the snack bar is consumed at breakfast and no additional food is consumed with that meal.

In one example, the snack bar can be consumed as part of a regimen of other fiber containing foods and supplements, in order to increase the amount of fiber she eats daily. In one example, the snack bar is consumed as part of a regimen that either meets or exceeds the fiber guidelines (38 and 25 g/day for men and women aged 19-50, respectively). For instance, in one example, a consumer may also eat a cereal with five or more grams of fiber per serving or may add unprocessed wheat bran to cereal, oatmeal, yogurt, or other foods. In another example, a consumer can also eat a regimen with sufficient amounts of fresh fruit such as berries including black berries, strawberries, raspberries, and blueberries, mangos, bananas, apples, pears, and oranges and/or dried fruit such as raisins, plums, figs, and apricots. In another example, a consumer can also eat a regimen with sufficient amounts of vegetables including greens such as collards, kale, and turnip greens, lima beans, mushrooms, potatoes with or without the skin, pumpkin, peas including black-eyed peas and green peas, peppers, rhubarb, spinach, and sweet potatoes. In another example a consumer may eat legumes such as chickpeas, navy beans, pinto beans, kidney beans, lentils, black beans, and the like. In another example, the consumer can eat whole wheat pastas and/or breads. In another example, the consumer is taking a fiber supplement containing psyllium, inulin, oligofructose guar gum, pectin, chitosan, cellulose, methylcellulose, beta-gucans, polydextrose, resistant dextrins, fructooligosaccharides, and/or acacia fibers.

In another example, the consumer is on a regimen to take or consume at least about 2 g soluble fiber per day from psyllium, in another example at least about 3 g, in another example at least about 4 g, in another example at least about 5 g, in another example at least about 6 g, and in another example at least about 7 g. In one example, this regimen can be completed through eating snack bars and/or taking a psyllium supplement, such as Metamucil® (distributed by the Procter & Gamble Co., Cincinnati, Ohio).

In one example the snack bar does not contain common allergens such as soy, milk, wheat, tree nuts, and/or peanuts. In one example, the snack bar is gluten free. In another example, the snack bar does not contain genetically modified ingredients. In another example, the snack bar has a low glycemic index. In another example, the snack bar can be dairy free. In another example the snack bar can contain no trans fats. In another example the snack bar can be low in sodium. In another example, the snack bar can be kosher. In another example, the snack bar does not contain artificial ingredients, in particular artificial flavors and coloring.

In another example, the bar does not contain chocolate. In another example, the snack bar does not contain additional vitamin and mineral supplements. In another example, the snack bar does not contain protein supplements. In another example, the snack bar does not contain ingredients with a high level of water, such as diluted juices. Chocolate, vitamins and mineral supplements, diluted juices, and protein supplements can reduce the shelf life of the product.

In one example, the snack bar is individually wrapped in food grade packaging, such as packaging made of monoaxially oriented polypropylene. The snack bars can be sold individually or packed into cartons containing multiple bars.

### Examples

TABLE 4

| | FiberWise ® | | FiberWise ® | | FiberWise ® | | Gnu ® | |
|---|---|---|---|---|---|---|---|---|
| | Chewy Fiber | | Chewy Fiber | | Chewy Fiber | | Foods Fiber | |
| | Bar¹ | | Bar¹ | | Bar¹ | | Love ™² | |
| Flavor | Oatmeal Raisin | | Apple | | Lemon Burst | | Chocolate | |
| | | | Cinnamon | | | | Brownie | |
| Serving Size | 45 | g | 45 | g | 45 | g | 45 | g |

Nutritional Facts Per Serving (% Daily Value based on a 2,000 calorie diet)

| | | | | |
|---|---|---|---|---|
| Calories | 150 | 140 | 160 | 140 |
| Calories from Fat | 25 | 15 | 25 | 35 |

| Total Fat | 3 | g (5%) | 2 | g (3%) | 3 | g (5%) | 4 | g (6%) |
|---|---|---|---|---|---|---|---|---|
| Saturated Fat | 1 | g (5%) | 0 | g | 0.5 | g (3%) | 1 | g (4%) |
| Trans Fat | 0 | g | 0 | g | 0 | g | 0 | g |
| Cholesterol | 0 | mg (0%) | 0 | mg (0%) | 0 | mg (0%) | 0 | mg (0%) |
| Sodium | 115 | mg (5%) | 70 | mg (3%) | 110 | mg (5%) | 30 | mg (2%) |
| Potassium | 115 | mg (3%) | n/a | | 90 | mg (3%) | n/a | |
| Total | 33 | g (11%) | 33 | g (11%) | 33 | g (11%) | 30 | g (10%) |
| Carbohydrate | | | | | | | | |
| Dietary Fiber | 9 | g (36%) | 6 | g (24%) | 9 | g (36%) | 12 | g (48%) |
| Soluble Fiber | 7 | g | n/a | | 7 | g | 8 | g |
| Sugars | 13 | g | 10 | g | 12 | g | 9 | g |
| Protein | 3 | g (6%) | 1 | g | 3 | g (6%) | 4 | g (6%) |

| | | | | |
|---|---|---|---|---|
| Vitamin A | 20% | 50% | 20% | 0% |
| Vitamin C | 20% | 50% | 20% | 0% |
| Calcium | 6% | 25% | 4% | 6% |
| Iron | 30% | 30% | 25% | 15% |

¹Purchased from Melaleuca at http://www.melaleuca.com on Apr. 12, 2011 and May 2, 2011
²Purchased from Gnu ® Foods at www.GnuFoods.com on Feb. 9, 2011

FiberWise® Chewy Fiber Bar (oatmeal raisin) ingredients, listed in descending order of prominence by weight: Granola (rolled oats, sugar, canola oil, honey, molasses), inulin-fructooligosaccharides, rice crisp (rice flour, malt extract, salt), raisins, agave syrup, honey, multigrain nuggets (whole wheat flour, degermed corn meal, whole oat flour, salt), psyllium husk, raisin paste, maltodextrin, sunflower oil, water, natural flavor, soy protein isolate, sugar, palm kernel and palm oil, skim milk powder, gum Arabic, whey protein concentrate, soy lecithin, spices, dry nonfat yogurt (skim milk, lactic acid, citric acid, bacteria culture), amino acid oligofructose complex mineral blend (calcium, magnesium, iron, zinc, manganese, copper, chromium, iodine, selenium, molybdenum), salt, vitamin blend (vitamin A palmitate, vitamin C [ascorbic acid], vitamin B3 [niacinamide], vitamin B2 [riboflavin], vitamin B1 [thiamine mononitrate], folic acid, vitamin E [d1 alpha tocopheryl acetate]), herbal blend (green tea, grape seed extract, peppermint leaves, ginger root and licorice root), titanium dioxide, citric acid.

FiberWise® Chewy Fiber Bar (apple cinnamon) ingredients, listed in descending order of prominence by weight: Apple cinnamon filling (crystalline maltitol, sugar, water, polydextrose, glycerin, modified food starch, apple powder [preserved with sulfur dioxide], cellulose, natural flavor, pectin, citric acid, locust bean gum, cinnamon, turmeric, annatto), enriched wheat flour (niacin, reduced iron, thiamine mononitrate, riboflavin, folic acid), maltitol syrup, psyllium husk, crystalline fructose, sugar, oat flour, polydextrose, corn starch, plum puree, vegetable glycerin, whey powder (milk), sunflower oil, barley flour, invert sugar syrup, palm oil, wheat bran flour, natural flavors, wheat bran, soy lecithin, mono and diglycerides, salt, vegetable gum (carrageenan, sodium chloride), baking soda, cream of tartar, aloe vera, grape seed, peppermint, ginger, licorice root, green tea, burdock root. Vitamin and mineral blend: calcium carbonate, vitamin C, vitamin B1, riboflavin, niacin, vitamin B6, vitamin B12, folic acid, beta carotene, vitamin E, zinc oxide, reduced iron.

FiberWise® Chewy Fiber Bar (lemon burst) ingredients, listed in descending order of prominence by weight: Granola (rolled oats, sugar, canola oil, honey, molasses), rice crisp (rice flour, malt extract, salt), inulin-fructooligosaccharides, multigrain nuggets (whole wheat flour, degermed corn meal, whole oat flour, salt), agave syrup, honey, psyllium husk, raisin paste, maltodextrin, sugar, water, sunflower oil, palm kernel and palm oil, soy protein isolate, skim milk powder, gum arabic, whey protein concentrate, natural flavor, lemon powder, soy lecithin, spices, dry nonfat yogurt (skim milk, lactic acid, citric acid, bacteria culture), amino acid oligofructose complex mineral blend (calcium, magnesium, iron, zinc, manganese, copper, chromium, iodine, selenium, molybdenum), salt, vitamin blend (vitamin A palmitate, vitamin C [ascorbic acid], vitamin B3 [niacinamide], vitamin B2 [riboflavin], vitamin B1 [thiamine mononitrate], folic acid, vitamin E [d1 alpha tocopheryl acetate]), herbal blend (green tea, grape seed extract, peppermint leaves, ginger root and licorice root), citric acid, titanium dioxide.

Gnu® Foods Fiber Love™ (chocolate brownie) ingredients, listed in descending order of prominence by weight: Gnu High Fiber Blend™ (whole rolled oats, organic whole wheat flour, wheat bran, organic KAMUT® brand Khorasan wheat, psyllium, flax, millet), chicory root inulin, fruit juices, rice dextrins, organic chocolate chips (cane sugar, chocolate liquor, cocoa butter, lecithin, vanilla), plums, non-GMO canola oil, vegetable glycerin, cocoa powder, wheat protein isolate, rice, natural flavors, vanilla, baking powder, salt.

TABLE 5

| | | | Quaker ® | | | |
|---|---|---|---|---|---|---|
| | | | Chewy ® | | | |
| | Example 1 | | Granola Bar³ | | ClifBar ®⁴ | |
| Flavor | Cinnamon Raisin | | Oatmeal Raisin | | Oatmeal Raisin | |
| | | | | | Walnut | |
| Serving Size | 40 | g | 24 | g | 68 | g |

Nutritional Facts Per Serving
(% Daily Value based on a 2,000 calorie diet)

| Calories | 150 | | 90 | | 240 | |
|---|---|---|---|---|---|---|
| Calories from Fat | 25 | | 15 | | 50 | |
| Total Fat | 2.5 | g (4%) | 1.5 | g (2%) | 5 | g (8%) |
| Saturated Fat | 0.5 | g (3%) | 0 | g (0%) | 0.5 | g (3%) |
| Trans Fat | 0 | g | 0 | g | 0 | g |
| Cholesterol | 0 | mg (0%) | 0 | mg | 0 | mg |
| Sodium | 90 | mg (4%) | 80 | mg | 160 | mg (7%) |
| Potassium | 80 | mg (2%) | n/a | | 240 | mg (7%) |
| Total | 31 | g (10%) | 19 | g (6%) | 43 | g (14%) |
| Carbohydrate | | | | | | |
| Dietary Fiber | 4 | g (16%) | 1 | g (4%) | 5 | g (20%) |
| Soluble Fiber | 3 | g | n/a | | n/a | |
| Sugars | 12 | g | 7 | g | 22 | g |
| Protein | 2 | g | 1 | g | 10 | g (20%) |

| | | | |
|---|---|---|---|
| Vitamin A | 0% | n/a | 10% |
| Vitamin C | 0% | n/a | 50% |
| Calcium | 2% | 8% | 25% |
| Iron | 4% | 2% | 25% |

³Purchased from Meijer ® , Fairfield, Ohio on Jul. 25, 2013 and Walmart.com on Jul. 26, 2013 (UPC 3000 31180, multiple boxes with best buy dates between Dec. 26, 2013 and Feb. 20, 2014)
⁴Purchased from Drugstore.com on Jul. 24, 2013 (Lot O0P1, best by Apr. 4, 2014)

Example 1 (cinnamon raisin) ingredients, listed in descending order of prominence by weight: Rolled oats, crisp rice (rice flour, malt extract, salt), corn syrup, invert sugar, granola (rolled oats, sugar, canola oil, honey, molasses), corn syrup solids, dried cranberries (cranberries, sugar, sunflower oil), psyllium husk, raisin paste, glycerin, sunflower oil, artificial and natural flavors, gum acacia, soy lecithin, salt, milk protein isolate, spice, tocopherols.

Quaker® Chewy® Granola Bar (oatmeal raisin) ingredients, listed in descending order of prominence: granola (whole grain rolled oats, brown sugar, crisp rice [rice flour, sugar, salt, malted barley extract], whole grain rolled wheat, soybean oil, whole wheat flour, sodium bicarbonate, soy lecithin, caramel color, nonfat dry milk), corn syrup, brown rice crisp (whole grain brown rice, sugar, malted barley flour, salt), raisins, oatmeal cookie pieces (sugar, enriched flour [wheat flour, niacin, reduced iron thiamin, mononitrate, riboflavin, folic acid], oats, soybean and/or palm oils, whole wheat flour, cinnamon, salt sodium bicarbonate), sugar, corn syrup solids, glycerin, invert sugar, soybean oil, contains 2% or less of sorbitol, calcium carbonate, fructose, salt, molasses, soy lecithin, natural and artificial flavor, cinnamon, creamed coconut, butylated hydroxytoluene (BHT), water, citric acid.

ClifBar® (oatmeal, raisin walnut) ingredients, listed in descending order of prominence by weight: organic brown rice syrup, ClifPro® (soy rice crisps [soy protein isolate, rice flour, rice starch, barley malt extract], organic soy flour, organic roasted soybeans), organic rolled oats, organic toasted oats (organic oats, organic dried cane syrup, ascorbic acid, natural vitamin E [antioxidant]), raisins, organic cane syrup, walnuts, ClifCrunch® (organic oat fiber, inulin [chicory extract], organic milled flaxseed, organic oat bran, psyllium), organic soy butter (organic roasted soybeans, organic soybean oil, salt), natural flavors, molasses powder, cinnamon, sea salt, natural vitamin E (antioxidant). Vitamins & minerals: dicalcium phosphate, calcium carbonate, ascorbic acid (vitamin C), magnesium oxide, d1-alpha-tocopheryl acetate (Vitamin E), ferric acid (Vitamin B9), riboflavin (Vitamin B2), sodium selenite, thiamin (Vitamin B1), pyridoxine hydrochloride (Vitamin B6), ergocalciferol (Vitamin D2), cyanocobalamin (Vitamin B12), chromium chloride, potassium iodide.

TABLE 6

| | | | Kashi ® Chewy | | | |
|---|---|---|---|---|---|---|
| | Example 2 | | Granola Bar⁵ | | LUNA ® Bar⁶ | |
| Flavor | Cranberry Lemon | | Berry Lemonade | | LemonZest ® | |
| Serving Size | 40 | g | 35 | g | 48 | g |

Nutritional Facts Per Serving
(% Daily Value based on a 2,000 calorie diet)

| Calories | 150 | | 130 | | 180 | |
|---|---|---|---|---|---|---|
| Calories from | 25 | | 15 | | 45 | |
| Fat | | | | | | |
| Total Fat | 2.5 | g (4%) | 1.5 | g (2%) | 5 | g (8%) |
| Saturated Fat | 1 | g (5%) | 0 | g | 2.5 | g |
| Trans Fat | 0 | g | 0 | g | 0 | g |
| Cholesterol | 0 | mg (0%) | 0 | mg | 0 | mg (0%) |
| Sodium | 115 | mg (5%) | 100 | mg (4%) | 115 | mg (5%) |
| Potassium | 105 | mg (3%) | n/a | | 110 | mg (3%) |
| Total | 30 | g (10%) | 23 | (g) | 27 | g (9%) |
| Carbohydrate | | | | | | |
| Dietary Fiber | 4 | g (16%) | 4 | g (15%) | 3 | g (12%) |
| Soluble Fiber | 3 | g | n/a | | n/a | |
| Sugars | 12 | g | 7 | g | 13 | g |
| Protein | 2 | g | 6 | g (9%) | 9 | g (18%) |

| | | | |
|---|---|---|---|
| Vitamin A | 0% | 0% | 20% |
| Vitamin C | 0% | 0% | 20% |
| Calcium | 2% | 2% | 35% |
| Iron | 4% | 6% | 30% |

⁵Purchased from Meijer ® Cincinnati, Ohio and Fairfield, Ohio and Walmart ® Cincinnati, Ohio and Mason, Ohio in July 2013 (Lot# REC61 and REC62, Best By December 2013)
⁶Purchased from Amazon.com on Jul. 24, 2013 (Lot #H63 6 3084A, best by Feb. 10, 2014)

Example 2 (cranberry lemon) ingredients, listed in descending order of prominence by weight: Rolled oats, corn syrup, crisp rice (rice flour, malt extract, salt), raisins, invert sugar, granola (rolled oats, sugar, canola oil, honey, molasses), corn syrup solids, psyllium husk, raisin paste, glycerin, white compound coating (sugar, palm kernel oil, corn syrup solids, whey protein isolate, titanium dioxide, soy lecithin, salt, natural and artificial flavors), sunflower oil, natural flavors, gum acacia, soy lecithin, salt, tocopherols.

LUNA® (LemonZest®) ingredients, listened in descending order of prominence by weight: LunaPro® (soy rice crisps [soy protein isolate, organic rice flour], organic toasted oats [organic rolled oats, organic dried cane syrup], organic roasted soybeans, organic soy flour, organic flax meal), organic brown rice syrup, coating (organic dried cane syrup, palm kernel oil, organic palm kernel oil, organic soy flour, organic soy lecithin, organic vanilla), inulin (chicory extract), lemon fruit pieces (organic dried cane syrup, glucose, lemon puree, pectin, citric acid, sodium citrate, natural flavor), organic soy butter (organic roasted soybeans, organic soybean oil, salt), organic oat syrup solids, vegetable glycerin, organic sunflower oil, natural flavor, organic natural flavors, citric acid, sea salt.

TABLE 7

| | | | | | Powerbar ® | |
|---|---|---|---|---|---|---|
| | | | | | Harvest | |
| Manufac- | | | Kellogg's ® Special | | Energy ™ | |
| turer | Example 3 | | K ® Cereal Bar⁷ | | Bar⁸ | |
| Flavor | Berry | | Red Berries | | Cranberry | |
| | | | | | Oatmeal | |
| | | | | | Cookie | |
| Serving Size | 40 | g | 23 | g | 35 | g |

Nutritional Facts Per Serving
(% Daily Value based on a 2,000 calorie diet)

| Calories | 150 | | 90 | | 130 | |
|---|---|---|---|---|---|---|
| Calories | 25 | | 15 | | 25 | |
| from Fat | | | | | | |
| Total Fat | 3 | g (5%) | 1.5 | (2%) | 2.5 | g (4%) |
| Saturated Fat | 1 | g (5%) | 1 | g (5%) | 0.5 | g (2%) |
| Trans Fat | 0 | g | 0 | g | 0 | g |
| Cholesterol | 0 | mg (0%) | 0 | mg | 0 | mg (0%) |
| Sodium | 75 | mg (3%) | 85 | mg | 90 | mg (4%) |
| Potassium | 80 | mg (2%) | n/a | | n/a | |
| Total Car- | 31 | g (10%) | 18 | g | 23 | g (8%) |
| bohydrate | | | | | | |
| Dietary Fiber | 4 | g (16%) | 3 | g (10%) | 2 | g (10%) |
| Soluble | 3 | g | n/a | | n/a | |
| Fiber | | | | | | |
| Sugars | 12 | g | 8 | g | 9 | g |
| Protein | 2 | g | Less than 1 | g | 5 | g (8%) |

| | | | |
|---|---|---|---|
| Vitamin A | 0% | 0% | 0% |
| Vitamin C | 0% | 0% | 0% |
| Calcium | 2% | 0% | 2% |
| Iron | 4% | 0% | 4% |

⁷Purchased from Meijer ®, Fairfield, Ohio on Jul. 25, 2013 and Amazon.com in July 2013 (UPC 38000 07778, best by Oct. 23, 2013)
⁸Purchased from Drugstore.com on Jul. 24, 2013 (Lot #3027573402, best by Nov. 23, 2013)

Example 3 (berry) ingredients, listed in descending order of prominence by weight: Rolled oats, corn syrup, crisp rice (rice flour, malt extract, salt), invert sugar, granola (rolled oats, sugar, canola oil, honey, molasses), corn syrup solids, dried cranberries (cranberries, sugar, sunflower oil), psyllium husk, raisin paste, glycerin, white compound coating (sugar, palm kernel oil, corn syrup solids, whey protein isolate, titanium dioxide, soy lecithin, salt, natural and artificial flavors), sunflower oil, natural flavors, gum acacia, soy lecithin, lemon powder, salt, citric acid, tocopherols.

Kellogg's® Special K® Cereal Bar (Red Berries) ingredients, listed in descending order of prominence by weight: cereal (rice, whole grain wheat, sugar, wheat bran, soluble wheat fiber, salt, malt flavoring, maltodextrin, thiamin mononitrate [vitamin B1], riboflavin [vitamin B2], corn syrup, soluble corn fiber, fructose, strawberry flavored fruit pieces (sugar, cranberries, citric acid, natural strawberry flavor with other natural flavors, elderberry, juice concentrate for color, sunflower oil), sugar, vegetable oil (soybean and palm oil with tertiary butylhydroquinone (TBHQ) for freshness, partially hydrogenated palm kernel oil), maltodextrin, contains two percent or less of dextrose, sorbitol, glycerin, nonfat dry milk, natural and artificial strawberry flavor, soy lecithin, salt, natural and artificial flavor, niacinamide, color added, pyridoxine, hydrochloride (vitamin B6), BHT.

Powerbar® Harvest Energy™ Bar (cranberry oatmeal cookie) ingredients, listed in descending order of prominence by weight: whole oats, cane invert syrup, high maltose brown rice syrup, soy crisps (soy protein isolate, rice flour, barley malt, salt), toasted soynuts, sweetened dried cranberries (sugar, cranberries), nonfat milk, oat fiber, oligofructose (from chicory root), high oleic canola oil, and less than 2% of: vegetable glycerin, sugar, citric acid, soy lecithin, salt, natural flavor, ground almonds, peanut butter.

### Water Activity Test Method

The water activity is defined as the ratio Aw=p/p₀, where p represents the actual partial pressure of water vapor and p₀ the maximum possible water vapor pressure of pure water (saturation pressure) at the same temperature. The Aw level is therefore dimensionless; pure water has a level of 1.0, and a completely water-free substance has a level of 0.0. The relationship between the equilibrium relative humidity ERH in a food and the water activity is Aw×100=ERH.

Instrument Conductivity humidity meter Rotronic Hygroskop DT (model WA-40 TH, available from Rotronic Measurement Solutions, Hauppauge, N.Y.) with an operational temperature range from 0 to 100° C., and 0 to 100% RH.

### Method

1. Weigh approximately 5 g of the snack bar sample and transfer it into a plastic bag.

2. Break or tear the sample into small pieces.

3. The samples to be measured are placed in small polysterene dishes in the bottom half of the measuring station.

4. Maintain the temperature constant by setting the equipment in a constant room temperature or by using a water bath connected to the cells.

5. Wait until the reading of Aw does not change anymore (reading is stable). A red light from the panel will indicate that the instrument is still reading a decrease or increase in value for Aw.

6. Remove the dish with the sample from the chamber and measure moisture content.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An RACC of an organoleptically acceptable psyllium snack bar comprising:
a. from about 3 g to about 6 g fiber wherein the fiber comprises from about 1 g to about 3 g soluble fiber and wherein at least a portion of the fiber comes from about 2 g to about 4 g psyllium;
b. a whole grain product;
wherein the snack bar comprises less than about 3 g fat and wherein the snack bar comprises from about 135 to about 180 calories per RACC and wherein the snack bar is not baked.

2. The psyllium snack bar of claim 1 wherein the snack bar comprises less than about 13 g sugar per RACC.

3. The psyllium snack bar of claim 1 comprising at least 2 g of soluble fiber.

4. The psyllium snack bar of claim 1 further comprising a dried fruit.

5. The psyllium snack bar of claim 1 wherein the psyllium comprises particles with a mean particle size from about 50 μm to about 200 μm.

6. The psyllium snack bar of claim 1 wherein the snack bar comprises a water activity from about 0.05 to about 0.35.

7. An RACC of an organoleptically acceptable psyllium snack bar comprising:
a. from about 0.5 g to about 4 g of soluble fiber from psyllium;
b. a whole grain;
c. a dried fruit;
wherein the snack bar is low in fat, low in saturated fat, and does not comprise cholesterol and wherein the snack bar is from about 100 to about 280 calories per RACC and wherein the snack bar comprises a weight ratio of protein to fiber of from about 0.25 to about 1.5.

8. The snack bar of claim 5 wherein the psyllium snack bar comprises less than about 15 g sugar per RACC.

9. The psyllium snack bar of claim 5 wherein the snack bar comprises from about 1 g to about 4 g of protein per RACC.

10. The psyllium snack bar of claim 5 wherein the snack bar comprises from about 5 g to about 20 g protein per RACC.

11. The psyllium snack bar of claim 5 wherein the snack bar comprises at least about 5 g of fiber per RACC.

12. The psyllium snack bar of claim 5 wherein the snack bar comprises from about 3 g of fiber to about 6 g of fiber per RACC.

13. The psyllium snack bar of claim 5 wherein the snack bar is not baked.

14. The psyllium snack bar of claim 5 wherein the snack bar comprises a weight ratio of sugar to fiber of from about 2 to about 4.

15. The psyllium snack bar of claim 5 wherein the snack bar comprises a weight ratio of fat to fiber of from about 0.4 to about 3.

16. The psyllium snack bar of claim 5 wherein the snack bar comprises from about 5 g to about 20 g protein per RACC.

17. An organoleptically acceptable psyllium snack bar comprising:
a. at least about 50 mg/g fiber wherein the fiber comprises at least about 25 mg/g soluble fiber;
b. at least about 10 mg/g psyllium;
c. a whole grain;
wherein the snack bar comprises a weight ratio of protein to fiber of from about 0.25 to about 1.5 and wherein a consumer prefers the psyllium snack bar to a psyllium snack bar that does not have a weight ratio of protein to fiber of from about 0.25 to about 1.5 in a taste test.

18. The psyllium snack bar of claim 14 wherein the snack bar has a shelf life of at least about 12 months.

19. The psyllium snack bar of claim 14 wherein the snack bar weighs from about 35 g to about 50 g.

20. The psyllium snack bar of claim 14 wherein the snack bar further comprises from about 0.1 to about 0.5 g sugar per g snack bar.
